(19) United States
(12) Patent Application Publication
(10) Pub. No.: US 2009/0155407 A1
(43) Pub. Date: Jun. 18, 2009

(54) Use of Food Composition Ingredients

(76) Inventors: Angelika de Bree, Vlaardingen (NL); Nathalie Marie Jeanne Van Der Put, Vlaardingen (NL)

Correspondence Address: UNILEVER PATENT GROUP, 800 SYLVAN AVENUE, AG West S. Wing, ENGLEWOOD CLIFFS, NJ, 07632-3100, US

(21) Appl. No.: 11/887,981

(22) PCT Filed: Mar. 7, 2006
(86) PCT No.: PCT/EP2006/002097

§ 371 Date: Feb. 21, 2008

(30) Foreign Application Priority Data
Apr. 7, 2005 (EP) 05075798.8

(51) Int. Cl. A23L 1/30; A23K 1/18; A23L 1/302

(52) U.S. Cl. 426/2

(57) ABSTRACT

Use of a combination of at least one B vitamin and at least one phytosterol or analogue or derivative thereof, for lowering blood pressure in a mammal.

### FIELD OF THE INVENTION

The present invention relates to use of combinations of ingredients in foodstuffs to lower blood pressure. In particular, it relates to anti-hypertensive use of B vitamins in combination with phytosterols and the like.

### BACKGROUND OF THE INVENTION

The B-vitamins, folic acid, vitamin B2, vitamin B6 and B12 are known to lower the homocysteine concentration [1, 2], the latter being accepted as a risk factor for cardiovascular diseases. In addition, several randomized controlled trials with combinations of these vitamins have shown that they also lower blood pressure [3-5].

Plant sterols and their analogues and derivatives are known for their LDL cholesterol lowering properties [6], LDL cholesterol being an established risk factor for atherosclerotic vascular diseases. No blood pressure lowering effect is known for these materials.

Some drinks, yoghurts and spreads which are currently on the market list B vitamins acid and phytostanol esters as amongst their ingredients. However, no blood pressure lowering activity has been attributed to those ingredients.

### DEFINITION OF THE INVENTION

The present invention provides use of a combination of one or more B-vitamins and one or more phytosterols or analogues or derivatives thereof, for lowering blood pressure in a mammal.

### DETAILED DESCRIPTION OF THE INVENTION

Use according to the present invention may comprise administration to a mammal such as a human, of at least one B-vitamin, in combination with one or more phytosterols, phytostanols or analogues or derivatives thereof in any form, for example in a pharmaceutical formulation containing that combination of ingredients and a pharmaceutically acceptable carrier therefor, such as in tablet, bolus or capsule form. However, it is preferred that the combination should be incorporated in a food product for consumption as part of a normal diet.

### The B Vitamins

The B vitamins are preferably selected from folic acid, vitamin B2, vitamin B6, vitamin B12 and mixtures thereof. The total amount of such substances in a food product or food supplement is preferably from 0.01% to 2,500%, more preferably from 15% to 500%, still more preferably from 30% to 200% from the Reference Labeling Values from the Scientific Committee on Food of the European Committee as of the date of filing of this application, namely folic acid: 200 μg, vitamin B2: 1.6 mg, vitamin B6: 2 mg, vitamin B12: 1 μg. The following preferred ranges of B vitamin inclusion levels are based on the assumption that the particular B vitamin in question is included in the combination. Preferably, the daily intake of folic acid from the combination is from 0.02 μg to 5,000 μg, more preferably from 30 μg to 1,000 μg, especially from 60 μg to 400 μg per day. The intake of vitamin B2 in such a combination is preferably from 0.2 mg to 40 mg, more preferably from 0.24 mg to 8 mg, especially from 0.5 mg to 3.2 mg per day. The intake of vitamin B6 in the combination is preferably from 0.2 mg to 50 mg, more preferably from 0.3 mg to 10 mg, especially from 0.6 mg to 4 mg per day. The intake of vitamin B12 from the combination is preferably from 0.00001 μg to 25 μg, more preferably from 0.15 μg to 5 μg, especially from 0.3 μg to 2 μg per day.

The Phytosterols, Phytostanols. Analogues and Derivatives

Typically, the phytosterols, phytostanols and their analogues and derivatives may be selected from one or more of phytosterols, phytostanols, synthetic analogues of phytosterols and phytostanols and esterified derivatives of any of the foregoing, and mixtures of any of these. The total amount of such substances in a food product or food supplement is preferably from 0.01% to 20%, more preferably from 0.1% to 15%, still more preferably from 0.2% to 8%, and most preferably from 0.3% to 8% by weight of the food product composition.

Preferably, the daily intake of such sterol-type component of the combination is from 0.1 g to 3 g, more preferably from 1.5 g to 2.5 g, especially from 2 g to 2.25 g per day. Phytosterols, also known as plant sterols or vegetable sterols can be classified in three groups, 4-desmethylsterols, 4-monomethylsterols and 4,4′-dimethylsterols. In oils they mainly exists as free sterols and sterol esters of fatty acids although sterol glucosides and acylated sterol glucosides are also present. There are three major phytosterols namely beta-sitosterol, stigmasterol and campesterol. Schematic drawings of the components meant are as given in “Influence of Processing on Sterols of Edible Vegetable Oils”, S. P. Kochhar; Prog. Lipid Res. 22: pp. 161-188.

The phytostanols are the respective 5α-saturated derivatives of phytosterols such as sitostanol, campestanol and their derivatives.

Synthetic analogues of any of the phytosterols or phytostanols (which include chemically modified natural phytosterols or phytostanols) may be used.

Preferably the phytosterol or phytostanol is selected from the group comprising fatty acid ester of β-sitosterol, β-sitostanol, campesterol, campestanol, stigmasterol, stigmastanol and mixtures thereof.

### Fatty Acid Esters

The optional phytosterol or phytostanol materials recited above may optionally be provided in the form of one or more fatty acid esters thereof. Mixtures of esterified and non-esterified materials may also be used.

Thus, any of the phytosterols, phytostanols and their synthetic analogues used in the present invention are preferably esterified with a fatty acid. Preferably, they are esterified with one or more C₂₋₂₂ fatty acids. For the purpose of the invention the term C₂₋₂₂ fatty acid refers to any molecule comprising a C₂₋₂₂ main chain and at least one acid group. Although not preferred within the present context the C₂₋₂₂ main chain may contain 1-6 double bonds, be partially substituted or side chains may be present. Preferably, however the C₂₋₂₂ fatty acids are linear molecules comprising one or two acid group(s) as end group(s). Most preferred are linear C₈₋₂₂ fatty acids as occur in natural liquid oils.

Suitable examples of any such fatty acids are acetic acid, propionic acid, butyric acid, caproic acid, caprylic acid, capric acid. Other suitable acids are for example citric acid, lactic acid, oxalic acid and maleic acid. Most preferred are lauric acid, palmitic acid, stearic acid, arachidic acid, behenic acid, oleic acid, cetoleic acid, erucic acid, elaidic acid, linoleic acid and linolenic acid.

When desired a mixture of fatty acids may be used for esterification of the sterols. For example, it is possible to use a naturally occurring fat or oil as a source of the fatty acid and to carry out the esterification via an interesterification reaction. Use of a natural source nearly always results in a mixture of fatty acids.

In a particular embodiment, the fatty acid mixture contains a high amount (>50%, preferably >70%, further preferred >80%) of unsaturates, being either monounsaturated fatty acids (MUFA) and/or polyunsaturated fatty acids (PUFA). This does not only provide the advantage of e.g. PUFA itself having good blood cholesterol lowering capacity, but also of the sterols esters prepared with such fatty acids.

Preferably fatty acid mixtures of sunflower, safflower, rapeseed, linseed, olive oil, linola and/or soybean are used. These are typical sources of high PUFA and/or low SAFA. Suitable esterification conditions are for example described in WO 92/19640.

### Optional Additional Ingredients

Other optional agents which may also be incorporated with the sterol-type and B vitamins include peptides, dietary fiber, either in soluble or insoluble form, soy protein, pro-biotic bacteria, other vitamins such as A, D and E.

Peptides are one preferred class of optional additional ingredients, comprising one or more peptides which are known to produce a hypotensive effect when orally ingested, especially those comprising 2 or 3 amino acid residues, for example those which are in the form of at least one peptide selected from the group comprising tripeptides VPP, IPP, LPP, and combinations thereof.

In the description herein concerning peptides, the common one letter code is ordinarily used to describe amino acids.

Larger blood pressure lowering peptides such as FFVAPFPEVFGK may also be used.

Preferably use of the combination in a food product in accordance with the present invention entails its incorporation in a product such as a spread, in a dairy product or analogue or derivative thereof, in a dough based product, in a ready-cook meal, in a beverage, a soup, a creamer or in an ice confection.

### EXAMPLES

The present invention will now be explained in more detail by way of the following non-limiting examples, and with reference to the accompanying drawings, in which:

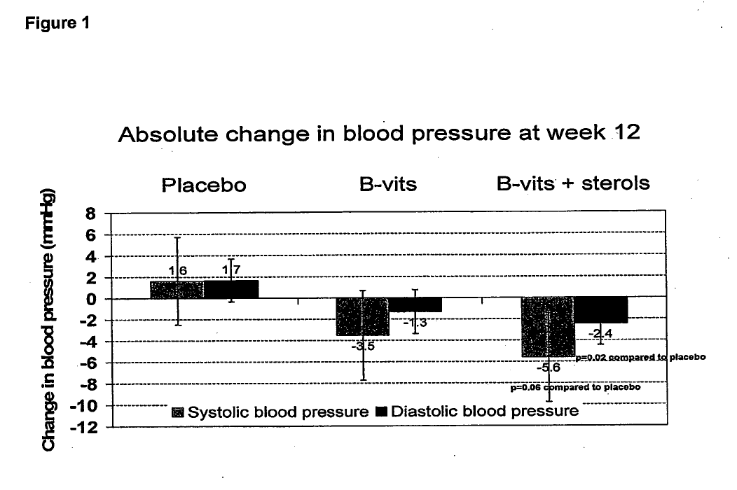

FIG. 1 is a graph of systolic and diastolic blood pressure change over the intervention period.

The effect on blood pressure of a combination of B-vitamins and plant sterols was tested in a randomized double-blind placebo controlled trial comparing the effect of a B-vitamin enriched spread with that of a B-vitamin and plant sterol enriched spread with that of a non-fortified spread (placebo).

### Subjects and Methods

### Subjects

Apparently healthy subjects were recruited from a pool of volunteers. All volunteers gave written informed consent before they underwent a screening procedure that included a health and lifestyle questionnaire, a physical examination and a routine blood clinical chemistry profile. A total of 125 subjects (51 males and 74 females) were included in the study. The most important eligibility criteria were an age between 20-75 years, normal clinical chemistry and haemotology results, with no medical history that could affect the study outcome, a plasma homocysteine concentration between 8 and 25 μmol/L, a total cholesterol concentration between 5 and 8 mmol/L, not taking hypertension medication, not using dietary B-vitamin supplements in the 3 months prior to baseline and during the study, and not using products fortified with plant sterols or stanols or omega-3 fatty acids 3 weeks prior to baseline and during the study.

### Study Design

The study was a randomized, placebo-controlled, doubleblind parallel study. The included subjects were stratified by age and gender and then randomly assigned to one of the three spreads. Each group had to consume 20 g spread/d for 12 weeks. The treatment spreads contained per 20 g: 1) 200 μg folic acid, 1 μg vitamin B12 and 1 mg vitamin B6, or 2) 200 μg folic acid, 1 μg vitamin B12 and 1 mg vitamin B6 and 2.25 g plant sterols, or 3) no B-vitamins and no sterols (placebo).

The study spreads were intended to replace an equivalent amount of the habitually used spread. The instruction was to preferably use the daily portion of 20 g spread on bread, but it was also allowed to put it on top of e.g. cooked vegetables. It was not allowed to used the spread for frying or baking. The subjects could divide the daily spread portion over the day or consume it all at once. They were instructed to store the spreads in a refrigerator.

Compliance was monitored and found to be appropriate.

### Spreads

The fortified spreads (35% fat) were prepared by Unilever Besffoods (URDV), VIaardingen, the Netherlands. The spreads were fortified with folic acid (pteroylglutamic acid (Folacin), Roche), vitamin B12 (cyanocobalamine, Roche) and vitamin B6 (pyridoxine hydrochloride, Roche). The composition of the spread is given in the table below.

| | Placebo | PSE + B vit. | B-vitamins |
|---|---|---|---|
| Water % (of total product) | 60.5 | 48.9 | 59.0 |
| SAFA % (of total fat) | 23.7 | 23.4 | 21.8 |
| MUFA % (of total fat) | 27.5 | 26.4 | 28.2 |
| PUFA % (of total fat) | 48.5 | 49.9 | 49.7 |
| trans % (of total fat) | 0.8 | 1.2 | 0.8 |
| Sterol content % (of total product) | <0.1 | 12 | <0.1 |
| Taste | good | good | good |
| Folic acid (μg/100 g) | — | 1099 | 1123 |
| Vitamin B6 (μg/100 g) | — | 6556 | 6522 |
| Vitamin B12 (μg/100 g) | — | 5.00 | 5.70 |

### Blood Pressure

Blood pressure was measured oscillometrically (Omron M4-I, Omron Healthcare Europe BV Hoofddorp, The Netherlands) in a horizontal position after a resting period of at least 5 minutes.

### Statistical Analysis

For each individual the absolute and relative (%) change in blood pressure, was calculated by subtracting the value obtained at baseline from the value obtained at week 12. Treatment effects were investigated using ANOVA (using the general linear model procedure as implemented in SAS).

Statistical analyses were carried out with SAS statistical software package SAS/STAT (version 8.02, SAS Institute, Cary, N.C.).

### Results

FIG. 1 shows the absolute changes in systolic and diastolic blood pressure between week 12 and baseline. In the treatment group that used the B-vitamin enriched spread, the decrease in systolic blood pressure was −3.5 mmHg (p>0.05 as compared to placebo) and the decreased in diastolic blood pressure was −1.3 mmHg (p>0.05 as compared to placebo). In the treatment group that used the B-vitamin sterol enriched spread, the decrease in systolic blood pressure was −5.6 mmHg (p=0.06 as compared to placebo) and the decreased in diastolic blood pressure was −2.4 mmHg (p<0.05 as compared to placebo). This corresponds to a 3.4% decrease in systolic blood pressure (p<0.05 as compared to placebo) and a 2.5% decrease in diastolic blood pressure (p<0.05 as compared to placebo) on the B-vitamin sterol enriched spread.

### REFERENCES

1. Clarke R, Armitage J. Vitamin supplements and cardiovascular risk: review of the randomized trials of homocysteine-lowering vitamin supplements. Semin Thromb Hemost 2000; 26:341-8.
2. Olszewski A J, Szostak W B, Bialkowska M, Rudnicki S, McCully K S. Reduction of plasma lipid and homocysteine levels by pyridoxine, folate, cobalamin, choline, riboflavin, and troxerutin in atherosclerosis [published erratum appears in Atherosclerosis 1991 May; 88(1):978]. Atherosclerosis 1989; 75:1-6.
3. van Dijk R A, Rauwerda J A, Steyn M, Twisk J W, Stehouwer C D. Long-term homocysteine-lowering treatment with folic acid plus pyridoxine is associated with decreased blood pressure but not with improved brachial artery endothelium-dependent vasodilation or carotid artery stiffness: a 2-year, randomized, placebo-controlled trial. Arterioscler Thromb Vasc Biol 2001; 21:2072-9.
4. Mangoni M, Sherwood R A, Swift C G, Jackson S H. Folic acid enhances endothelial function and reduces blood pressure in smokers: a randomized controlled trial. J Intern Med 2002; 252:497-503.
5. Schufte A E, Huisman H W, Oosthuizen W, van Rooyen J M, Jerling J C. Cardiovascular effects of oral Supplementation of vitamin C, E and folic acid in young healthy rmales. Int J Vitam Nutr Res 2004; 74:285-93.
6. Katan M B, Grundy S M, Jones P, Law M, Miettinen T, Paoletti R. Efficacy and safety of plant stanols and sterols in the management of blood cholesterol levels. Mayo Clin Proc 2003; 78:965-78.

1. Use of a combination of one or more B vitamins, and one or more phytosterols or analogues or derivatives thereof, for the preparation of a food product for lowering blood pressure in a mammal, wherein the B group vitamin is selected from vitamin B2, vitamin B6, vitamin B12, folic acid and mixtures thereof, and the total amount of such substances in a food product or food supplement is preferably from 0.01% to 2,500%, more preferably from 15% to 500%, still more preferably from 30% to 200% from the Reference Labeling Values from the Scientific Committee on Food of the European Committee as of the date of filing of this application and the food product comprises 0.01 to 20 wt % of phytosterol or analogues or derivatives thereof.

2. Use according to claim 1, wherein said phytosterol, analogue or derivative thereof is selected from phytosterols, phytosterol fatty acid esters, phytostanols, phytostanol fatty acid esters and synthetic analogues thereof and mixtures thereof.

3. Use according to claim 1 wherein the amount of vitamin B2 in the food product is 30% to 200% of 1.6 mg.

4. Use according to claim 1 wherein the amount of vitamin B6 in the food product is 30% to 200% of 2 mg.

5. Use according to claim 1, wherein the amount of vitamin B12 in the food product is 30% to 200% of 1 μg.

6. Use according to claim 1, wherein the amount of folic acid in the food product is 30% to 200% of 200 μg.

7. Use according to claim 3 wherein the food product comprises
(a) 30% to 200% of 1.6 mg vitamin B2; and
(b) 30% to 200% of 2 mg vitamin B6; and
(c) 30% to 200% of 1 μg vitamin B12; and
(d) 30% to 200% of 200 μg folic acid.

8. Use according to claim 1 wherein the food product is a spread, a dairy product, a dough based product, a ready-cook meal, a beverage, a soup, a creamer or an ice-confection.

9. Use according to claim 1, wherein said combination is used in the presence also of one or more other ingredients, for example selected from peptides, dietary fiber, either in soluble or insoluble form, soy protein, pro-biotic bacteria and other vitamins such as A, D and E.
